(19) United States
(12) Patent Application Publication
(10) Pub. No.: US 2022/0413416 A1
(43) Pub. Date: Dec. 29, 2022

(54) TONER TRANSPORT DEVICE, AND DEVELOPING DEVICE AND IMAGE FORMING APPARATUS INCLUDING TONER TRANSPORT DEVICE

(71) Applicant: KYOCERA Document Solutions Inc., Osaka (JP)

(72) Inventors: Hiroaki KITAGAWA, Osaka (JP); Koichi IMANAKA, Osaka (JP)

(73) Assignee: KYOCERA Document Solutions Inc., Osaka (JP)

(21) Appl. No.: 17/762,041

(22) PCT Filed: Apr. 14, 2021
(86) PCT No.: PCT/JP2021/015381

§ 371 Date: Mar. 18, 2022

(30) Foreign Application Priority Data
Apr. 22, 2020 (JP) 2020-075794

(51) Int. Cl. G03G 15/08

(52) U.S. Cl. CPC G03G 15/0891

(57) ABSTRACT

In a toner supply device (40), a horizontal transport portion (42) is connected to a vertical transport portion (41). A stirring transport screw (25) includes a rotary shaft (25a) and a supply blade (25c), and transports toner in the horizontal transport portion (42) toward the rotary shaft (25a). A drive input gear (50) inputs a rotational drive force to the rotary shaft (25a). A crank shaft (47) has a central shaft (47a) connected to the drive input gear (50) and is rotated at a lower speed than the rotary shaft (25a), and an eccentric shaft (47c) extending in parallel to the central shaft (47a) from a position radially outward from the central shaft. One end of the toner loosening member (45) is connected to the eccentric shaft (47c), and the toner loosening member (45) is reciprocatingly moved in the vertical direction in the vertical transport portion (41) due to a circumferential movement operation of the eccentric shaft (47c) centered on the central shaft (47a).

### TECHNICAL FIELD

The present invention relates to a toner transport device that transports toner, and in particular, a technique relating to a toner transport device including a vertical transport portion that drops toner in a vertical direction and a horizontal transport portion that is connected to the vertical transport portion and transports the toner in a horizontal direction, and a developing device and an image forming apparatus including the toner transport device.

### BACKGROUND ART

An image forming apparatus using an electrophotographic method, such as a copier, a printer, or a facsimile apparatus, includes an image carrier such as a photoconductor drum that carries an electrostatic latent image, a developing device that develops the electrostatic latent image into a toner image by supplying toner to the image carrier, and a toner container that supplies the toner to the developing device.

The toner supplied from the toner container passes through a toner supply path provided in the developing device and is moved to a stirring device of the developing device. In this case, the toner that freely falls in the toner supply path adheres to an inner wall surface of the toner supply path and aggregates, resulting in toner clogging.

Thus, a method of eliminating toner clogging in the toner supply path has been proposed. For example, Patent Literature 1 discloses a toner supply device in which a transport member that transports toner with its rotation is disposed inside a first transport path, and a transport member disposed inside a second transport path is moved in a vertical direction by converting rotating motion of the transport member into reciprocating motion via a crank-shaped shaft provided in the transport member.

Patent Literature 2 discloses a toner transport device that includes a toner supply pipe provided to extend in a vertical direction, a toner loosening member provided to be able to reciprocate in the vertical direction inside the toner supply pipe, a toner transport pipe through which an upper portion of the toner supply pipe communicates with a toner container accommodating toner for supply, a transport screw rotatably provided inside the toner transport pipe, and a crank portion that converts rotating motion of the transport screw into reciprocating motion of the toner loosening member.

### CITATION LIST

### Patent Literature

### [Patent Literature 1]

Japanese Unexamined Patent Application Publication No. 2001-296731

### [Patent Literature 2]

Japanese Unexamined Patent Application Publication No. 2017-191176

### SUMMARY OF INVENTION

The transport screw that stirs and transports toner needs to be rotated at a high speed in order to secure a transport amount and a transport speed of the toner. On the other hand, it is not necessary to reciprocatingly move the toner loosening member for loosening the aggregated toner at a high speed, and it is sufficient to slide the toner loosening member at a low speed along an inner wall surface of a toner transport path.

In the configurations disclosed in Patent Literatures 1 and 2, since the transport screw that transports the toner is provided with a crank mechanism, the rotation of the transport screw and the crank mechanism is synchronized. Thus, when the transport screw is rotated at a high speed, the toner loosening member is also reciprocatingly moved at a high speed, and there is a problem in that the toner loosening member causes wear and rubbing noise of the toner transport path.

In view of the above problems, an object of the present invention is to provide a toner transport device capable of achieving both high-speed rotation of a transport member and low-speed reciprocating movement of a toner loosening member with a simple configuration, and a developing device and an image forming apparatus including the toner transport device.

According to an aspect of the present invention, there is provided a toner transport device including a vertical transport portion, a horizontal transport portion, a transport member, a drive input gear, a toner loosening member, and a crank shaft. The vertical transport portion drops toner vertically and transports the toner. The horizontal transport portion is connected to the vertical transport portion and transports the toner in the horizontal direction. The transport member has a rotary shaft disposed in the horizontal transport portion in a toner transport direction and a supply blade protruding from an outer peripheral surface of the rotary shaft, and rotates the rotary shaft such that the toner in the horizontal transport portion is transported in a rotary shaft direction by the supply blade. The drive input gear inputs a rotational drive force to the rotary shaft. The toner loosening member is disposed to be movable in the vertical direction in the vertical transport portion. The crank shaft has a central shaft connected to the drive input gear and rotated at a lower speed than the rotary shaft, and an eccentric shaft extending in parallel to the central shaft from a position radially outward from the central shaft. One end of the toner loosening member is connected to the eccentric shaft, and the toner loosening member is reciprocatingly moved in the vertical direction due to a circumferential movement operation of the eccentric shaft centered on the central shaft when the crank shaft is rotated.

According to another aspect of the present invention, there is provided a developing device including a developing container, a developer carrier, and the toner transport device. The developing container stores a developer containing toner. The developer carrier is rotatably supported at the developing container and carries the developer in the developing container. The horizontal transport portion is connected to the developing container.

According to still another aspect of the present invention, there is provided an image forming apparatus including the toner transport device and an image forming device that forms an image by using the toner.

### Advantageous Effects of Invention

According to the present invention, since one end of the toner loosening member connected to the eccentric shaft of the crank shaft is circumferentially moved on a circular orbit, the toner loosening member is reciprocatingly moved up and down along the inner wall surface of the vertical transport portion. As a result, since a scraping operation is executed due to the reciprocating movement of the toner loosening member inside the vertical transport portion, it is possible to suppress agglomeration of the toner in the vertical transport portion. Since the toner loosening member is reciprocatingly moved up and down due to the rotational operation of the transport member, a separate drive source for moving the toner loosening member is not required, and agglomeration of toner in the vertical transport portion can be suppressed with a simple and low cost configuration. Since the crank shaft is rotated at a lower speed than the transport member, the crank shaft can be rotated at a low speed even in a case where the transport member is rotated at a high speed. Therefore, the toner loosening member can be reciprocatingly moved at a low speed, and thus wear and rubbing noise of the vertical transport portion due to the toner loosening member can be effectively suppressed.

### BRIEF DESCRIPTION OF DRAWINGS

FIG. 1 is a schematic sectional view showing an internal structure of an image forming apparatus equipped with a developing device including a toner supply device of the present invention.

FIG. 2 is a side sectional view showing a structure of the developing device mounted on the image forming apparatus.

FIG. 3 is an external perspective view of the developing device when viewed from an opposite side to a photoconductor drum.

FIG. 4 is a side view of the developing device when viewed from the toner supply device side.

FIG. 5 is a partial sectional view including the toner supply device of the developing device.

FIG. 6 is an exploded perspective view showing a state in which a cover member is detached from a main body of the toner supply device.

FIG. 7 is a side view showing a state in which the cover member is detached from the main body of the toner supply device.

FIG. 8 is a perspective view showing a drive transmission mechanism of the developing device.

FIG. 9 is a partially enlarged view of a crank shaft in FIG. 8.

### DESCRIPTION OF EMBODIMENTS

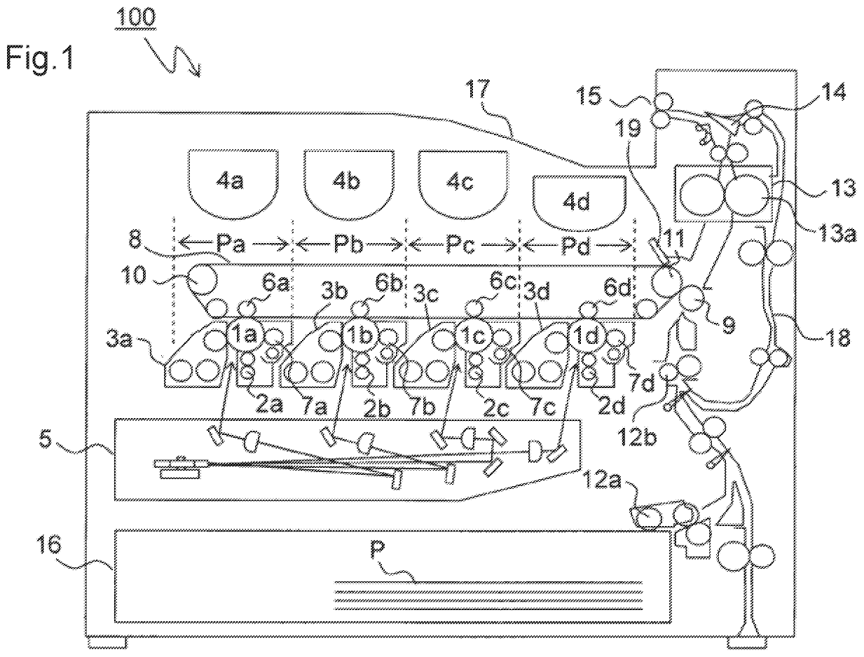

Hereinafter, embodiments of the present invention will be described with reference to the drawings. FIG. 1 is a sectional view showing an internal structure of an image forming apparatus 100 equipped with developing devices 3a to 3d including a toner supply device of the present invention. In the image forming apparatus 100 (here, a color printer), four image forming devices Pa, Pb, Pc, and Pd are disposed in order from an upstream side in the transport direction (left side in FIG. 1). The image forming devices Pa to Pd are provided to correspond to images of four different colors (cyan, magenta, yellow, and black). The image forming devices Pa, Pb, Pc, and Pd sequentially form cyan, magenta, yellow and black images through respective steps such as charging, exposure, development, and transfer.

Photoconductor drums (image carriers) 1a, 1b, 1c, and 1d carrying visible images (toner images) of the respective colors are respectively disposed in the image forming devices Pa to Pd. An intermediate transfer belt 8 that is rotated counterclockwise by driving means in FIG. 1 is provided adjacent to the image forming devices Pa to Pd. The toner images formed on the photoconductor drums 1a to 1d are sequentially primarily transferred and superimposed on the intermediate transfer belt 8 that is moved while contacting the photoconductor drums 1a to 1d. The toner image primarily transferred onto the intermediate transfer belt 8 is secondarily transferred onto transfer paper P as an example of a recording medium by a secondary transfer roller 9. The transfer paper P on which the toner image is secondarily transferred is discharged from a main body of the image forming apparatus 100 after the toner images are fixed in a fixing device 13. The image forming devices Pa to Pd respectively execute image forming processes on the photoconductor drums 1a to 1d while rotating the photoconductor drums 1a to 1d clockwise in FIG. 1.

The transfer paper P on which the toner image is secondarily transferred is accommodated in a paper cassette 16 disposed at a lower part of the main body of the image forming apparatus 100. The transfer paper P is transported to a nip portion between the secondary transfer roller 9 and a driving roller 11 of the intermediate transfer belt 8 via a paper feed roller 12a and a resist roller pair 12b. As the intermediate transfer belt 8, a sheet made of a dielectric resin and having no seam (seamless) is mainly used. A blade-shaped belt cleaner 19 for removing toner and the like remaining on the surface of the intermediate transfer belt 8 is disposed on the downstream side of the secondary transfer roller 9.

Next, the image forming devices Pa to Pd will be described. Charging devices 2a, 2b, 2c and 2d that respectively charge the photoconductor drums 1a to 1d, an exposure device 5 that exposes image information on each of the photoconductor drums 1a to 1d, developing devices 3a, 3b, 3c, and 3d that respectively form toner images on the photoconductor drums 1a to 1d, and cleaning devices 7a, 7b, 7c, and 7d that respectively remove a developer (toner) and the like remaining on the photoconductor drums 1a to 1d are provided around and below the rotatably disposed photoconductor drums 1a to 1d.

When image data is input from a host device such as a personal computer, first, the charging devices 2a to 2d uniformly charge the surfaces of the photoconductor drums 1a to 1d. Next, the exposure device 5 applies light according to the image data, and forms an electrostatic latent image according to the image data on each of the photoconductor drums 1a to 1d. The developing devices 3a to 3d are filled with a predetermined amount of a two-component developer containing toner of cyan, magenta, yellow, and black, respectively. In a case where a proportion of the toner in the two-component developer filling each of the developing devices 3a to 3d falls below a defined value due to formation of toner images that will be described later, toner is supplied from the toner containers 4a to 4d to the developing devices 3a to 3d, respectively. The toner in the two-component developer is supplied onto the photoconductor drums 1a to 1d by the developing devices 3a to 3d, and electrostatically adheres to the electrostatic latent images formed through the exposure by the exposure device 5, and thus toner images corresponding to the electrostatic latent images are formed.

An electric field is applied between the primary transfer rollers 6a to 6d and the photoconductor drums 1a to 1d at a predetermined transfer voltage by the primary transfer rollers 6a to 6d, and cyan, magenta, yellow, and black toner images on the photoconductor drums 1a to 1d are primarily transferred onto the intermediate transfer belt 8. The four-color toner images are formed with a predetermined positional relationship defined in advance for forming a predetermined full-color image. Thereafter, in preparation for subsequent formation of a new electrostatic latent image, the cleaning devices 7a to 7d remove the toner and the like remaining on the surfaces of the photoconductor drums 1a to 1d after the primary transfer.

The intermediate transfer belt 8 is hung on a driven roller 10 on the upstream side and the driving roller 11 on the downstream side. When the intermediate transfer belt 8 starts to be rotated counterclockwise with rotation of the driving roller 11 by the drive motor, the transfer paper P is transported to the nip portion (secondary transport nip portion) between the driving roller 11 and the secondary transfer roller 9 provided adjacent to the driving roller 11 at a predetermined timing from the resist roller pair 12b, and thus the four-color toner images on the intermediate transfer belt 8 are secondarily transferred onto the transfer paper P. The transfer paper P on which the toner images are secondarily transferred is transported to the fixing device 13.

The transfer paper P transported to the fixing device 13 is heated and pressurized by a fixing roller pair 13a, and thus the toner images are fixed on the surface of the transfer paper P to form a predetermined full-color image. The transfer paper P on which the full-color image is formed is distributed in a transport direction by a branch 14 that is branched in a plurality of directions, and is discharged to a discharge tray 17 by a discharge roller pair 15 as it is (or after being sent to a double-sided transport path 18 such that an image is formed on both sides thereof).

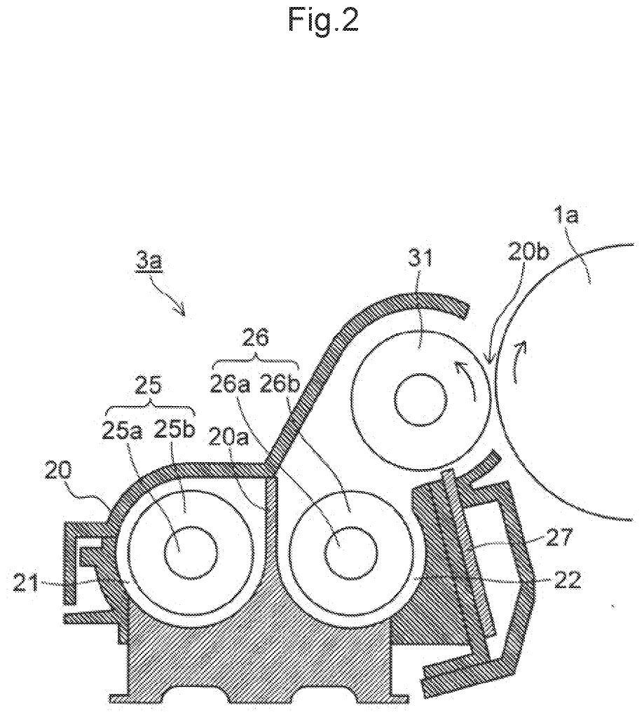

FIG. 2 is a side sectional view of the developing device 3a mounted on the image forming apparatus 100. In the following description, the developing device 3a disposed in the image forming device Pa in FIG. 1 is exemplified, but configurations of the developing devices 3b to 3d disposed in the image forming devices Pb to Pd are basically the same, and thus description thereof will be omitted.

As shown in FIG. 2, the developing device 3a includes a developing container 20 in which a two-component developer (hereinafter, simply referred to as a developer) containing a magnetic carrier and toner is stored. The developing container 20 is divided into a stirring transport chamber 21 and a supply transport chamber 22 by a partition wall 20a. In the stirring transport chamber 21 and the supply transport chamber 22, a stirring transport screw 25 and a supply transport screw 26 for mixing and stirring the toner supplied from the toner container 4a (refer to FIG. 1) with the magnetic carrier and charging the toner are rotatably disposed, respectively.

The stirring transport screw 25 disposed in the stirring transport chamber 21 has a rotary shaft 25a and a transport blade 25b that is provided integrally with the rotary shaft 25a and is formed spirally at a constant pitch in the axial direction of the rotary shaft 25a. The rotary shaft 25a is rotatably supported at the developing container 20. By rotating the stirring transport screw 25, the developer in the stirring transport chamber 21 is transported in a predetermined direction (one side in the axial direction of the developing roller 31) while being stirred.

The supply transport screw 26 disposed in the supply transport chamber 22 has a rotary shaft 26a and a transport blade 26b that is provided integrally with the rotary shaft 26a and is spirally formed by blades facing the same direction (having the same winding direction) as the transport blade 25b. The rotary shaft 26a is disposed in parallel to the rotary shaft 25a of the stirring transport screw 25, and is rotatably supported at the developing container 20. By rotating the supply transport screw 26, the developer in the supply transport chamber 22 is transported in the direction opposite to that of the stirring transport screw 25 while being stirred, and is supplied to the developing roller 31 (developer carrier).

The developer is transported in the axial direction (direction perpendicular to the paper surface in FIG. 2) while being agitated by the stirring transport screw 25 and the supply transport screw 26. The developer is circulated between the stirring transport chamber 21 and the supply transport chamber 22 via developer passage paths formed at both ends of the partition wall 20a. That is, a circulation path for the developer is formed in the developing container 20 by the stirring transport chamber 21, the supply transport chamber 22, and the developer passage path.

The developing container 20 extends diagonally upward to the right in FIG. 2. The developing roller 31 is disposed diagonally above the right side of the supply transport screw 26 in the developing container 20. A part of the outer circumferential surface of the developing roller 31 is exposed from an opening 20b of the developing container 20 and faces the photoconductor drum 1a. The developing roller 31 is rotated counterclockwise in FIG. 2. A developing voltage in which an AC voltage is superimposed on a DC voltage is applied to the developing roller 31.

The developing roller 31 is configured with a cylindrical developing sleeve that is rotated counterclockwise in FIG. 2 and a magnet having a plurality of magnetic poles fixed in the developing sleeve. Although a developing sleeve having a knurled surface is used here, a developing sleeve having a large number of depressed shapes (dimples) formed on the surface or a developing sleeve having a blasted surface may also be used.

A regulation blade 27 is attached to the developing container 20 along the longitudinal direction of the developing roller 31 (a direction perpendicular to the paper surface of FIG. 2). A slight gap is formed between the tip of the regulation blade 27 and the surface of the developing roller 31.

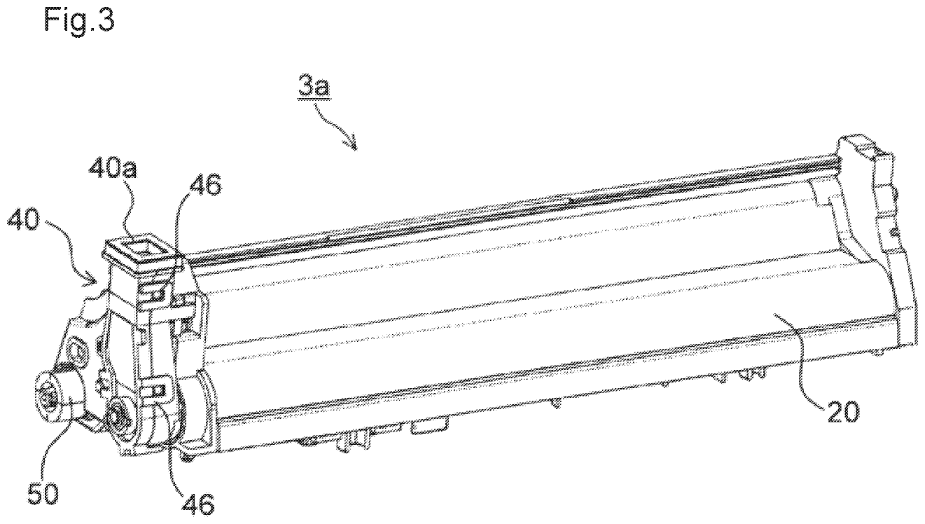

FIG. 3 is an external perspective view of the developing device 3a when viewed from the opposite side (left side of FIG. 2) to the photoconductor drum 1a. At one end (left end in FIG. 3) of the developing device 3a, a toner supply device 40 that supplies toner from the toner container 4a (refer to FIG. 1) into the developing container 20 is provided. A toner supply port 40a for receiving toner from the toner container 4a is formed at the upper end of the toner supply device 40. A drive input gear 50 is disposed on the side surface of the developing container 20 on the toner supply device 40 side.

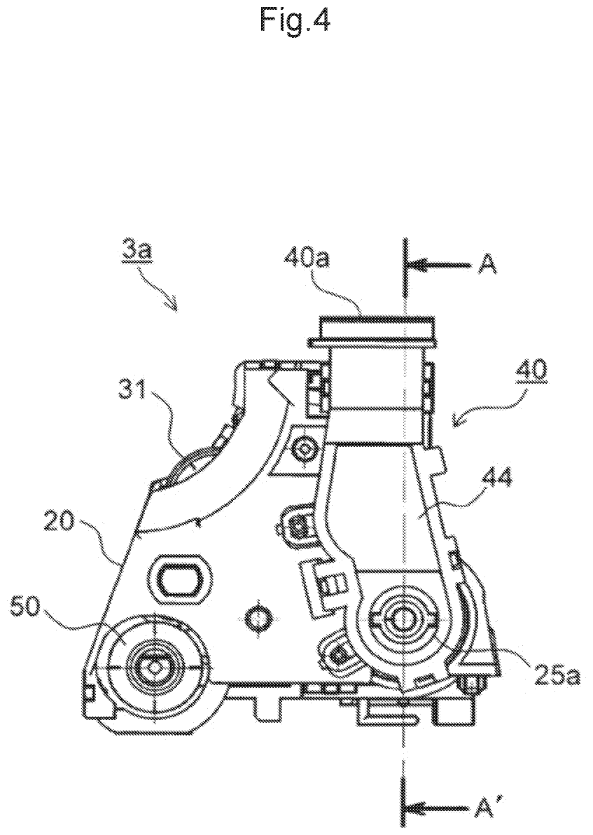

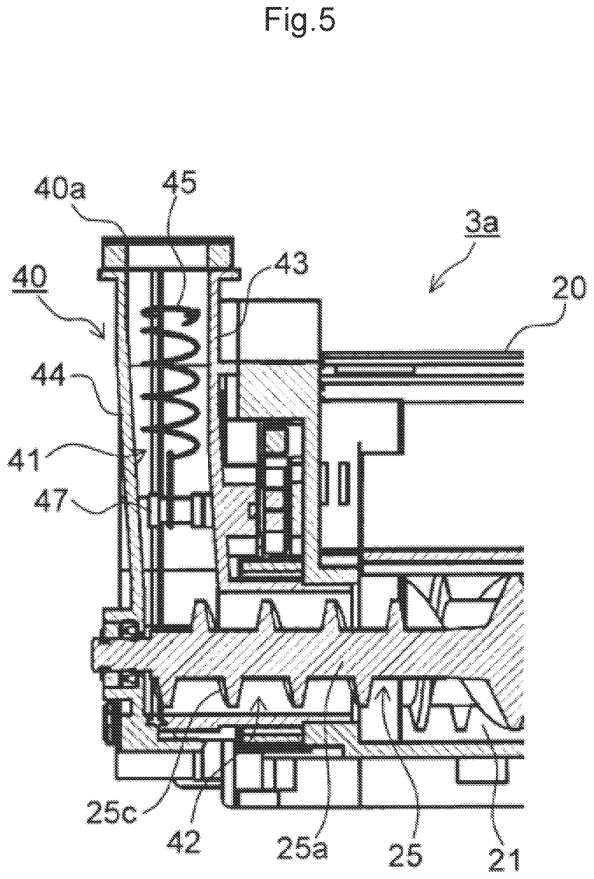

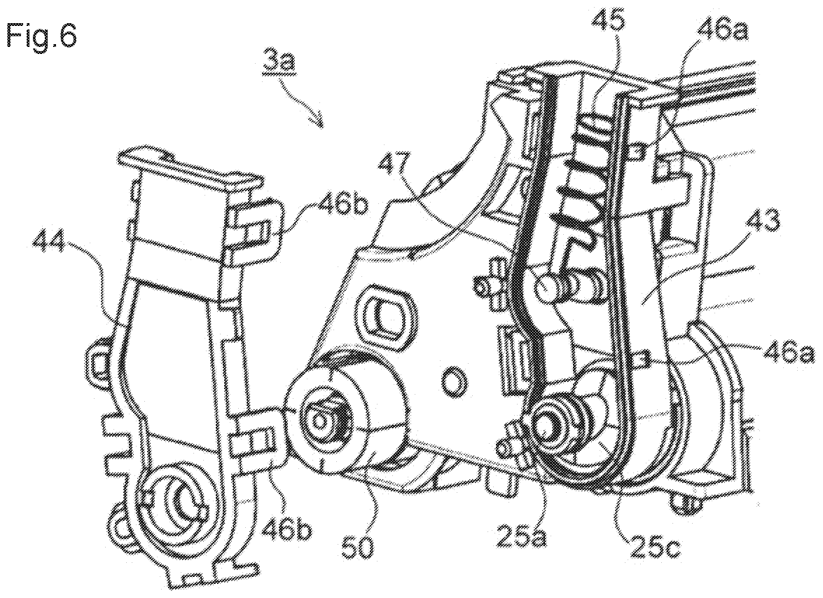

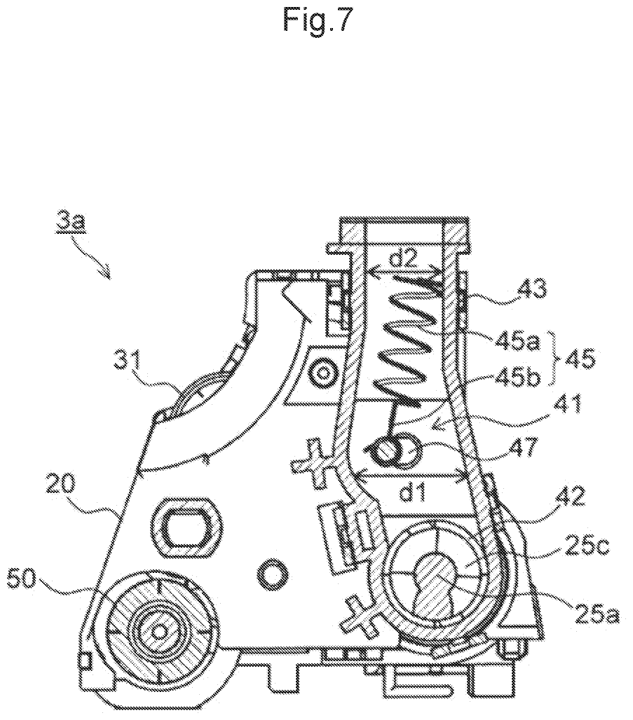

FIG. 4 is a side view of the developing device 3a when viewed from the toner supply device 40 side. FIG. 5 is a partial sectional view (sectional view along the arrows AA′ in FIG. 4) including the toner supply device 40 of the developing device 3a. FIGS. 6 and 7 are respectively an exploded perspective view and a side view showing a state in which a cover member 44 is detached from a main body 43 of the toner supply device 40. As shown in FIG. 5, the toner supply device 40 has a vertical transport portion 41 that transports (drops) toner in the vertical direction and a horizontal transport portion 42 that horizontally transports the toner delivered from the vertical transport portion 41.

The vertical transport portion 41 is configured with two members such as the main body 43 and the cover member 44. The main body 43 is integrally formed with the side surface of the developing container 20. A locking claw 46a (refer to FIG. 6) is formed on the side surface of the main body 43. An engaging portion 46b (refer to FIG. 6) is formed on the side surface of the cover member 44. The locking claw 46a and the engaging portion 46b configure a snap fit 46 (refer to FIG. 3). The cover member 44 is detachably joined to the main body 43. As shown in FIGS. 6 and 7, the vertical transport portion 41 is divided into two in the vertical direction by detaching the cover member 44 from the main body 43.

The rotary shaft 25a of the stirring transport screw 25 extends into the horizontal transport portion 42. The supply blade 25c is integrally formed with a portion of the rotary shaft 25a of the stirring transport screw 25 disposed in the horizontal transport portion 42. The supply blade 25c is formed by spiral blades facing in the same direction as that of the transport blade 25b (in the same winding direction), and is formed with a smaller pitch and a smaller diameter than those of the transport blade 25b.

The toner supplied from the toner container 4a (refer to FIG. 1) to the toner supply device 40 via the toner supply port 40a passes through the vertical transport portion 41 and falls onto the horizontal transport portion 42 connected to the vertical transport portion 41. The supply toner that has fallen to the horizontal transport portion 42 is transported in the horizontal direction (to the right in FIG. 5) by the supply blade 25c of the stirring transport screw 25, and enters the stirring transport chamber 21 of the developing container 20 connected to the horizontal transport portion 42 along the rotary shaft 25a. The supply toner that has entered the stirring transport chamber 21 is charged with a predetermined charge amount by being stirred and mixed with the developer (the developer delivered from the supply transport chamber 22) in the stirring transport chamber 21. That is, the stirring transport screw 25 also serves as a transport member that transports the toner in the horizontal transport portion 42 toward the stirring transport chamber 21.

A toner loosening member 45 is disposed in the vertical transport portion 41. The toner loosening member 45 has a coil portion 45a formed by bending a metal wire (spring material) into a coil shape, and a connecting portion 45b extending linearly from a lower end of the coil portion 45a. The connecting portion 45b is connected to a crank shaft 47 (eccentric shaft 47c) formed to protrude from the main body 43 into the toner supply device 40. An outer diameter of the coil portion 45a is smaller than an inner diameter of the vertical transport portion 41. The toner loosening member 45 is disposed to be movable in the vertical direction in the vertical transport portion 41.

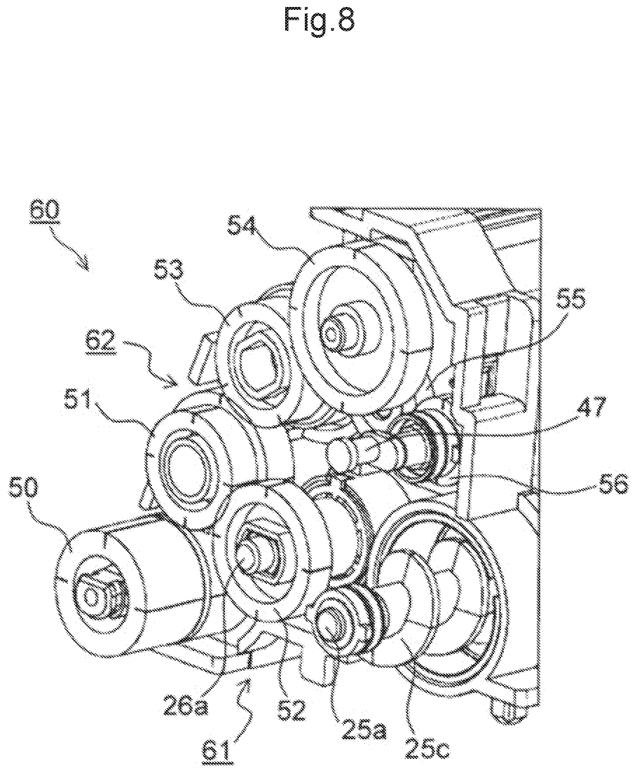

The drive input gear 50 transmits the rotational drive force of the developing drive motor to the stirring transport screw 25, the supply transport screw 26, the developing roller 31, and the crank shaft 47 via a drive transmission mechanism 60 (refer to FIG. 8) that will be described later.

FIG. 8 is a perspective view showing the drive transmission mechanism 60 of the developing device 3a. The drive transmission mechanism 60 has the drive input gear 50 protruding from the side surface of the developing container 20, and first gears 51 to sixth gears 56 disposed inside the side surface of the developing container 20.

The first gear 51 is a two-stage gear that meshes with the drive input gear 50. The second gear 52 is fixed to the rotary shaft 26a of the supply transport screw 26. The second gear 52 meshes with a small diameter portion of the first gear 51 to transmit the rotational drive force to the supply transport screw 26. Drive transmission gears that mesh with each other are fixed to the rotary shaft 26a and an opposite end to the rotary shaft 25a, and thus the rotational drive force is also transmitted to the stirring transport screw 25. The first gear 51 and the second gear 52 form a first drive transmission gear train 61 that transmits the rotational drive force to the stirring transport screw 25 and the supply transport screw 26.

The third gear 53 is fixed to the rotary shaft of the developing roller 31. The third gear 53 meshes with a large diameter portion of the first gear 51 to transmit the rotational drive force to the developing roller 31. The sixth gear 56 is connected to the third gear 53 via the fourth gear 54 and the fifth gear 55. The sixth gear 56 is fixed to the crank shaft 47. The sixth gear 56 transmits the rotational drive force to the crank shaft 47. The first gear 51 and the third gears 53 to the sixth gear 56 form a second drive transmission gear train 62 that transmits the rotational drive force to the crank shaft 47.

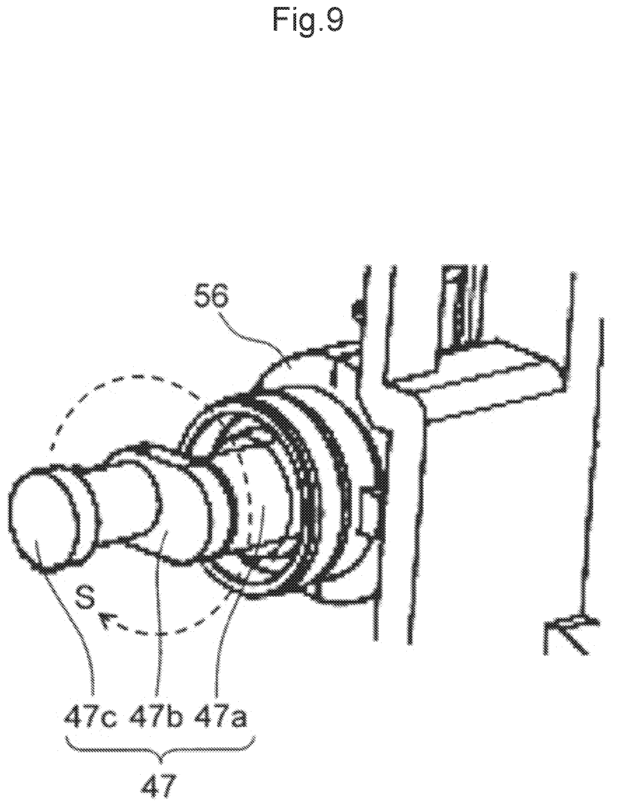

FIG. 9 is a partially enlarged view of the crank shaft 47 in FIG. 8. The crank shaft 47 has a central shaft 47a to which the sixth gear 56 is fixed, an arm portion 47b protruding radially from the tip of the central shaft, and an eccentric shaft 47c protruding from the arm portion 47b to the opposite side to the central shaft 47a. The connecting portion 45b (refer to FIG. 7) of the toner loosening member 45 is connected to the eccentric shaft 47c.

When the sixth gear 56 rotates, the central shaft 47a also rotates together with the sixth gear 56. As shown in FIG. 9, the eccentric shaft 47c of the crank shaft 47 extends in parallel to the central shaft 47a from a position radially deviated from the central shaft 47a. As a result, the eccentric shaft 47c is circumferentially moved on a circular orbit S (indicated by the dashed line in FIG. 9) centered on the central shaft 47a as the central shaft 47a is rotated.

Therefore, since the connecting portion 45b of the toner loosening member 45 connected to the eccentric shaft 47c of the crank shaft 47 is also circumferentially moved on the circular orbit S, the coil portion 45a of the toner loosening member 45 is reciprocatingly moved up and down along the inner wall surface of the vertical transport portion 41. As a result, the inside of the vertical transport portion 41 is in a state in which a scraping operation is executed by the reciprocating movement of the toner loosening member 45, and thus it is possible to effectively suppress the toner from being agglomerated in the vertical transport portion 41. Therefore, it is possible to smoothly supply the toner from the toner containers 4a to 4d to the developing devices 3a to 3d.

Since the toner loosening member 45 is reciprocatingly moved up and down due to the rotational operation of the stirring transport screw 25, a dedicated drive source for reciprocatingly moving the toner loosening member 45 is not required, and agglomeration of toner in the vertical transport portion 41 can be suppressed with a simple and low cost configuration.

The second drive transmission gear train 62 that transmits the rotational drive force to the crank shaft 47 has a higher reduction ratio than that of the first drive transmission gear train 61 that transmits the rotational drive force to the stirring transport screw 25 and the supply transport screw 26.

Consequently, even in a case where the stirring transport screw 25 and the supply transport screw 26 are rotated at a high speed, the crank shaft 47 can be rotated at a low speed. Therefore, the toner loosening member 45 can be reciprocatingly moved at a low speed, and thus the wear and rubbing noise of the vertical transport portion 41 by the toner loosening member 45 can be effectively suppressed.

As shown in FIG. 7, an opening width d1 below the crank shaft 47 of the vertical transport portion 41 is larger than an opening width d2 above the crank shaft 47. That is, a sectional area of the vertical transport portion 41 below the crank shaft 47 (the opposite side to the toner loosening member 45) is larger than a sectional area above the crank shaft 47 (toner loosening member 45 side). As a result, it is possible to prevent the aggregation of toner below the crank shaft 47, which has no scraping effect by the toner loosening member 45.

The present invention is not limited to the above embodiment, and various modifications can be made without departing from the concept of the present invention. For example, in the above embodiment, as the toner loosening member 45, the toner loosening member 45 having a coil spring shape has been exemplified, but this is an example. For example, a toner loosening member having a protrusion piece or a protruding strip extending radially from a core material extending in the vertical direction may be used.

In the above embodiment, the stirring transport screw 25 in which the spiral supply blades 25c are continuously provided around the rotary shaft 25a is used, but the supply blade 25c is not limited to a spiral blade. For example, a plurality of crescent-shaped plates (circular plates divided into two) may be alternately disposed around the rotary shaft 25a at a predetermined inclination angle to form the supply blades 25c.

In the above embodiment, the toner supply device 40 that supplies the toner from the toner containers 4a to 4d to the developing devices 3a to 3d has been described, but an application of the toner transport device according to the present invention is not limited to the toner supply device 40. For example, the present invention is applicable to a toner transport device in which a vertical transport portion and a horizontal transport portion are connected, such as a waste toner transport device that transports waste toner from the cleaning devices 7a to 7d (refer to FIG. 1) to a waste toner collecting container.

The present invention is not limited to the tandem color printer 100 shown in FIG. 1, and is applicable to various image forming apparatuses including a toner transport device in which the horizontal transport portion is located downstream of the vertical transport portion, such as a digital or analog monochrome copier, a color copier, or a facsimile.

### INDUSTRIAL APPLICABILITY

The present invention can be used for a toner transport device having a vertical transport portion and a horizontal transport portion connected to the lower end of the vertical transport portion. By utilizing the present invention, it is possible to suppress aggregation of toner in the vertical transport portion and smoothly transport the toner. By utilizing the present invention, it is possible to provide a toner transport device that can suppress wear and rubbing noise of a toner loosening member by achieving both high-speed rotation of a transport member and low-speed reciprocating movement of the toner loosening member with a simple configuration.

1. A toner transport device comprising:
a vertical transport portion that drops toner vertically and transports the toner;
a horizontal transport portion that is connected to the vertical transport portion and transports the toner in a horizontal direction;
a transport member that has a rotary shaft disposed in the horizontal transport portion in a toner transport direction and a supply blade protruding from an outer peripheral surface of the rotary shaft, and rotates the rotary shaft such that the toner in the horizontal transport portion is transported in a rotary shaft direction by the supply blade;
a drive input gear that inputs a rotational drive force to the rotary shaft;
a toner loosening member that is disposed to be movable in a vertical direction in the vertical transport portion; and
a crank shaft that has a central shaft connected to the drive input gear and rotated at a lower speed than the rotary shaft, and an eccentric shaft extending in parallel to the central shaft from a position radially outward from the central shaft, wherein
one end of the toner loosening member is connected to the eccentric shaft, and the toner loosening member is reciprocatingly moved in the vertical direction due to a circumferential movement operation of the eccentric shaft centered on the central shaft when the crank shaft is rotated.

2. The toner transport device according to claim 1, wherein
the crank shaft is formed to protrude inside the vertical transport portion, and
the vertical transport portion is formed such that a sectional area on a side opposite to the toner loosening member with the crank shaft interposed therebetween is larger than a sectional area on a toner loosening member side.

3. The toner transport device according to claim 1, further comprising:
a first drive transmission gear train that is connected between the drive input gear and the transport member; and
a second drive transmission gear train that is connected between the drive input gear and the crank shaft, wherein
the second drive transmission gear train has a higher reduction ratio than that of the first drive transmission gear train.

4. The toner transport device according to claim 1, wherein
the toner loosening member has a coil portion in which a metal wire is curved into a coil shape, and a connecting portion formed at one end of the coil portion and connected to the eccentric shaft.

5. The toner transport device according to claim 4, wherein
the horizontal transport portion is connected to a lower end of the vertical transport portion,
the crank shaft is formed to protrude inside the vertical transport portion lower of the vertical transport portion, and
the toner loosening member is disposed above the crank shaft.

6. The toner transport device according to claim 1, wherein
the crank shaft further includes an arm portion that protrudes radially from a tip of the central shaft, and
the eccentric shaft protrudes from the arm portion to an opposite side to the central shaft.

7. A developing device comprising:
a developing container that stores a developer containing toner;
a developer carrier that is rotatably supported at the developing container and carries the developer in the developing container; and
the toner transport device according to claim 1, wherein
the horizontal transport portion is connected to the developing container.

8. An image forming apparatus comprising:
the toner transport device according to claim 1; and
an image forming device that forms an image by using the toner.
